(19) United States
(12) Patent Application Publication
(10) Pub. No.: US 2003/0171834 A1
(43) Pub. Date: Sep. 11, 2003

(54) Method and apparatus for connecting a portable media player wirelessly to an automobile entertainment system

(76) Inventor: Kelan C. Silvester, Portland, OR (US)

Correspondence Address: John Patrick Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/094,220

(22) Filed: Mar. 7, 2002

(51) Int. Cl. G06F 17/00; H04R 29/00

(52) U.S. Cl. 700/94; 381/58; 381/77

(57) ABSTRACT

Embodiments of the invention provides a method comprising disabling audio playback through a loudspeaker unit of a first media player; establishing a wireless link with a second media player using said first media player; and transmitting a signal via said wireless link to said second media, said signal including an audio signal associated with a medium currently being played in said first media player. Embodiments of the invention also provides the method comprising establishing a wireless link with a second media player using a first media player; receiving a signal from said second media; said signal including an audio signal associated with a medium currently being played in said second media player; and converting said signal into sound which is played via a loudspeaker associated with the first media player.

### FIELD OF THE INVENTION

This invention relates to entertainment. In particular in relates to portable entertainment devices and to automobile entertainment systems.

### BACKGROUND

There are many portable entertainment devices on the market today. These include MPEG (MP3) players, portable radios, cassette players, and compact disc (CD), and Digital Versatile Disc (DVD) players. Even notebook computers today can be regarded as portable entertainment devices in that many include CD and DVD players. These portable entertainment devices are often used in an automobile equipped with a high quality entertainment system capable of playing high quality audio in a variety of formats, such as Dolby Digital 5.1. However, there is no way to take advantage of the superior audio qualities of such an automobile entertainment system while playing a medium on a portable entertainment device in the automobile.

### BRIEF DESCRIPTION OF THE DRAWINGS

FIG. 1 shows a block diagram of an automobile entertainment system in accordance with one embodiment of the invention;

FIG. 2 shows a block diagram of a media player in accordance with one embodiment of the invention;

FIG. 3 shows a flow chart of operations performed by the automobile entertainment system of FIG. 1;

FIG. 4 shows a block diagram of a display unit of the automobile entertainment system of FIG. 1;

FIG. 5 shows an example of the command set for the portable media player of FIG. 2;

FIG. 6 shows a flow chart of operations performed by the media player of FIG. 2;

FIG. 7 shows a flow chart of operations performed by the media player of FIG. 2 when in a playback state; and

FIG. 8 shows a flow chart of operations performed by the automobile entertainment system of FIG. 1 when in a playback state.

### DETAILED DESCRIPTION

A method and apparatus for connecting a portable media player wirelessly to an automobile entertainment system is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

According to one embodiment, the invention provides a method comprising disabling audio playback through a loudspeaker unit of a first media player; establishing a wireless link with a second media player using said first media player; and transmitting a signal via said wireless link to said second media player, said signal including an audio signal associated with a medium currently being played in said first media player.

According to another embodiment, the invention provides a method comprising establishing a wireless link with a second media player using a first media player; receiving a signal from said second media player; said signal including an audio signal associated with a medium currently being played in said second media player; and converting said signal into sound which is played via a loudspeaker associated with said first media player.

According to a further embodiment of the invention, there is provided a portable media player comprising a disabling mechanism to disable audio playback through a loudspeaker unit of said portable media player; and a wireless communications interface to transmit a signal to a second media player, said signal including an audio signal associated with a medium in said portable media player.

According to yet a further aspect of the invention, there is provided apparatus comprising a wireless communications interface to establish a wireless communications link with a portable media player; a receiving mechanism to receive a signal from said media player, said signal including an audio signal associated with a medium currently being played in said media player; and a conversion mechanism for converting said signal into sound which is played via a loudspeaker associated with said apparatus.

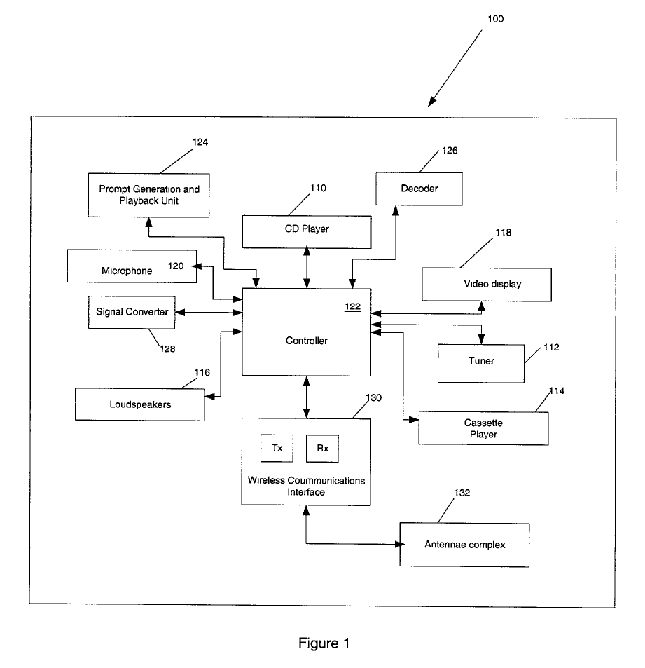

Referring to FIG. 1 of the drawings, a system according to one embodiment of the invention in the form of the automobile entertainment system is indicated generally by reference numeral 100. FIG. 1 is a block diagram and includes only those components necessary to describe the present invention. Components of system 100 not necessary for purposes of describing the present invention have been omitted so as to not to obscure the present invention. However, these components will necessarily be understood by a person of ordinary skill in the art to form part of system 100.

The components of system 100 shown in FIG. 1 include a compact disc (CD) player 110, a tuner 112, a cassette player 114, a set of loudspeakers 116, a video display 118, and a microphone 120. Each of these components are connected to a controller 122 which controls operation of the various components. The system 100 further includes a prompt generation and playback unit 124, a decoder 126, a signal converter 128 and a wireless communications interface 130, all of which are coupled to controller 122. Further, an antenna complex 132 is coupled to wireless communications interface 130. Wireless communications interface 130 may support wireless standards known as Bluetooth™ and IEEE 802.11. The operation of system 100 will be described in greater detail below.

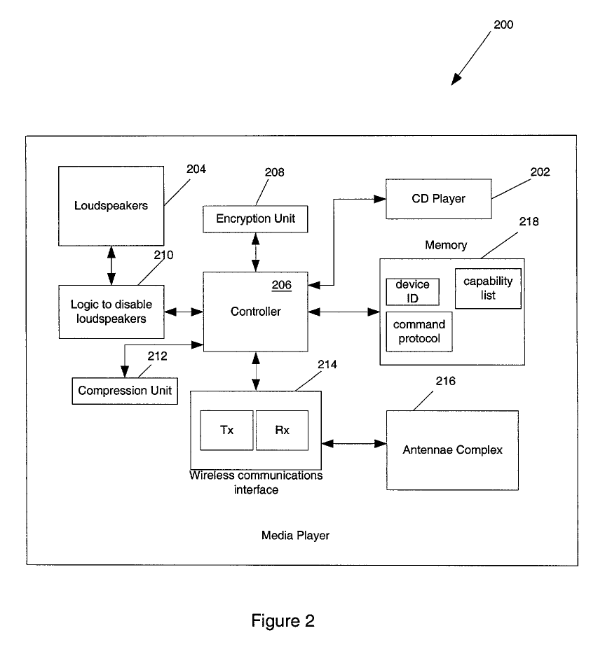

Referring to FIG. 2 of the drawings, a portable media player in accordance with one embodiment of the invention is indicated generally by reference numeral 200. As with FIG. 1, FIG. 2 is a block diagram showing only those components necessary to describe the media player 200. Thus, components necessarily forming part of media player 200 but not necessary to describe the inventive aspects of media player 200 have not been shown so as to avoid obscuring the inventive aspects of media player 200. However, one skilled in the art will necessarily understand that these components form part of media player 200. As shown, media player 200 includes a CD player 202 and loudspeakers 204 each of which are connected to a controller 206. Other components of media player 200 include an encryption unit 208, logic 210 to disable loudspeakers 204, a compression unit 212, a wireless communications interface 214 connected to an antenna complex 216, and a memory 218. The operation of media 200 will be described in greater detail below.

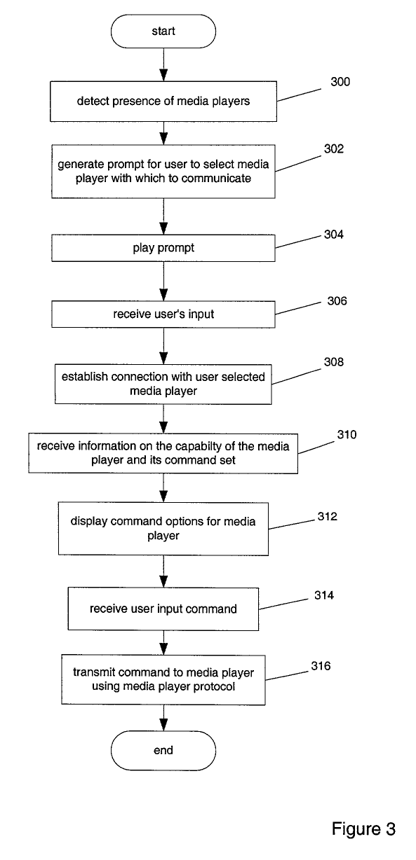

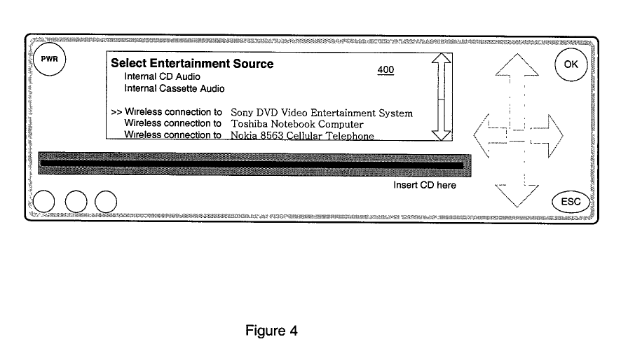

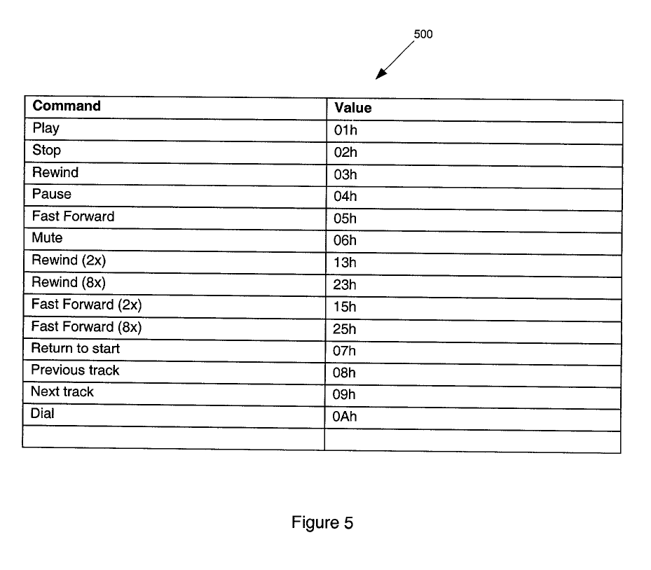

Referring now to FIG. 3 of the drawings, a flow chart of operations performed by system 100 in accordance with one embodiment of the invention is shown. Starting at block 300, system 100 detects the presence of media players within its immediate vicinity. This is achieved by continuously polling for a wireless communications signal in the form of an IEEE 802.11 signal or a Bluetooth™ signal from a media player within the immediate vicinity of system 100. If a media player has been detected, at 302 system 100 generates a prompt to prompt a user to select the media player with which to communicate. In some embodiments the prompt may be a visual prompt. In other embodiments the prompt may be an audio prompt. At block 304 the prompt is played. FIG. 4 of the drawings shows an example of a visual prompt which is displayed on an LCD screen 400 associated with system 100. The visual prompt shown in FIG. 4 offers a user choices between devices including a DVD system, a notebook computer and a cellular telephone with which system 100 can communicate. At block 306, system 100 receives the user's input regarding with which portable media player or device communications is to be established. Typically, a user will make the selection via buttons on a faceplate associated with entertainment system 100. However, in the case of the prompt being an audio prompt then a user's selection will be in the form of a voice command which will be deciphered by system 100 using standard voice recognition algorithms. To facilitate discussion, it is assumed that media player 200 has been selected. At block 306, system 100 establishes a communications link with media player 200. At block 310, system 100 receives information on the functionality or capabilities of the media player 200 and a command set of media player 200. The command set includes simple protocol standards for device control defined so as to allow system 100 to control playback of media player 200. FIG. 5 of the drawings shows an example of a simple protocol 500 which can be used by system 100 to control playback media player 200.

Referring to FIG. 5 it will be seen that commands such as play, stop, rewind, etc. have been assigned a hexadecimal value. Thus, transmission of the hexadecimal value for a particular command from system 100 to portable media player 200 will cause the portable media player to perform the command associated with the hexadecimal value. Thus, essentially block 310 involves communicating the command set and its associated hexadecimal values for portable media player 200 to system 100. In response system 100, at block 312, displays the command options available for media player 200. For example, these commands will include play, stop, rewind, pause, fast-forward, etc. At block 314 system 100 receives a user-input command which may, for example, be a “play” command. In response, at block 316, system 100 transmits the value associated with the user-input command, for example the “01h” which corresponds to the “play” command to media player 200, thus causing the media player 200 to change its state to a playback state.

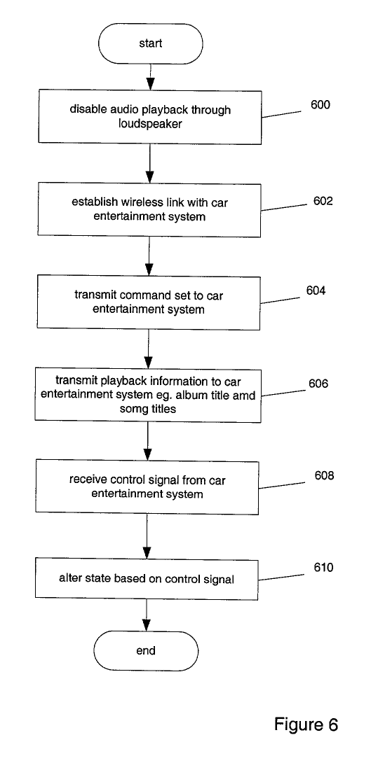

Referring to FIG. 6 of the drawings, a flow chart of the operations performed by media player 200 in accordance with one embodiment of the present invention is shown. Starting at block 600, media player 200 disables audio playback through loudspeakers 204. At block 602, media player 200 establishes a wireless link with system 100. At block 604 media player 200 transmits its command set to system 100. An example of command set is shown in FIG. 5 of the drawings. At block 606, media player 200 transmits playback information to system 100. For example, this information could include an album title and song titles associated with a CD currently in media player 200. At block 606 media player 200 receives a control signal from system 100. The control signal may be a command to cause media player 200 to alter its state at block 610 based on the control signal. For example, media player 200 could have been in a stop state and in response to receiving the value “01h” from system 100, media player 200 will alter its state to move to a playback state.

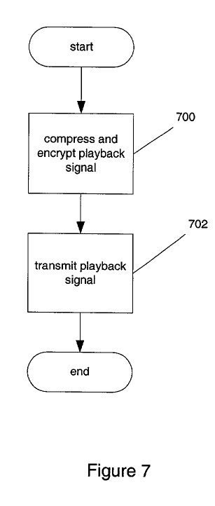

FIG. 7 of the drawings shows a flowchart of operations performed by media player 200 when in a playback state. Starting at block 700, media player 200 compresses and encrypts a playback signal and transmits this playback signal at block 702 to system 100. Compression of the playback signal allows more information to be transmitted from media player 200 to system 100 for a given bandwidth. This is advantageous when transmitting a significant amount of information. For example, in the case of a video signal being transmitted from a portable DVD player. Encrypting the playback signal enhances privacy in that the signal cannot be picked up and played by an extraneous system which could be for example, in an adjacent automobile.

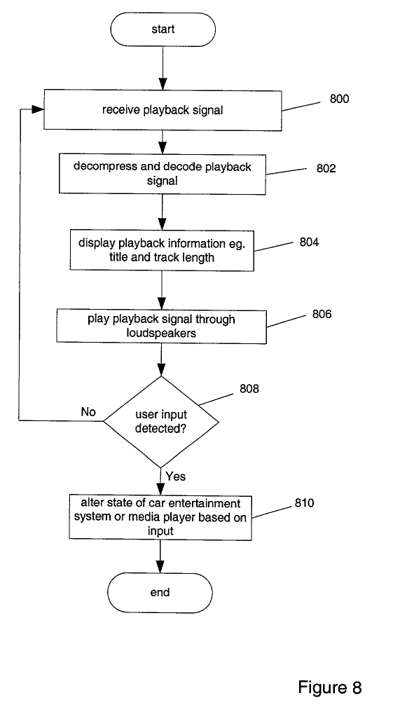

FIG. 8 of the drawings shows a sequence of operations performed by system 100 in accordance with another embodiment of the invention. Starting at block 800, system 100 receives the encrypted and compressed playback signal from media player 200. At block 802, system 100 decompresses and decodes the playback signal. This is done by decoder 126 of system 100. At block 804 system, 100 displays the playback information associated with the media currently in media player 200. For example, in the case of a compact disc, this information would include the title and track length of each track in the compact disc. At block 806, system 100 plays back the playback signal through loudspeakers 116. This is achieved by converting the signal in signal converter 128 into an audio signal. At 808, system 100 detects if a user has entered an input. If no user input is detected, system 100 repeats block 800. If user input has been detected then at block 810 system 100 alters its state or the state of media player 200 in response. For example, if the input is to pause playback, then system 100 will transmit the value “04h” to media player 200 to cause media player 200 to move to a pause state. Alternatively, system 100 may shut down if the input is to turn off system 100.

One advantage of the present invention is that it allows a user to operate a portable media player such as a compact disc player, a notebook computer, a MP3 player, a portable radio, a cassette player, etc. within an automobile to take advantage of the superior quality audio of an entertainment system in the automobile.

It will be apparent from this description the aspects of the present invention may be embodied, at least partly, in software. In other embodiments, hardware circuitry may be used in combination with software instructions to implement the present invention. Thus, the techniques are not limited to any specific combination of hardware circuitry and software.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method comprising:
disabling audio playback through a loudspeaker unit of a first media player;
establishing a wireless link with a second media player using said first media player; and
transmitting a signal via said wireless link to said second media player, said signal including an audio signal associated with a medium currently being played in said first media player.

2. The method of claim 1, wherein said wireless link complies with a communication standard selected from the group comprising a standard known as Bluetooth™, and a standard known as IEEE 802.11.

3. The method of claim 1, wherein said signal comprises a video signal.

4. The method of claim 3, further comprising compressing said signal before transmission.

5. The method of claim 4, further comprising encrypting said signal before transmission.

6. The method of claim 1, wherein said signal comprises information identifying components of said signal.

7. The method of claim 1, wherein said second media player is an entertainment system of an automobile.

8. A method comprising:
establishing a wireless link with a second media player using a first media player;
receiving a signal from said second media player, said signal including an audio signal associated with a medium currently being played in said second media player; and
converting said signal into sound which is played via a loudspeaker associated with said first media player.

9. The method of claim 8, wherein establishing a wireless link comprises detecting a presence of one or more second media players and prompting a user to select said or one of said second media players with which to establish said wireless link.

10. The method of claim 9, wherein prompting a user comprises playing a prompt message and receiving said user's input in response.

11. The method of claim 9, wherein said prompt message is an audio prompt message played through said loudspeaker.

12. The method of claim 9, wherein said prompt message is a visual prompt message played through a visual display associated with said first media player.

13. A portable media player comprising:
a disabling mechanism to disable audio playback through a loudspeaker unit of said portable media player; and
a wireless communications interface to transmit a signal to a second media player, said signal including an audio signal associated with a medium in said portable media player.

14. The portable media player of claim 13, wherein said wireless communications interface supports a standard selected from the group comprising a standard known as Bluetooth™; and a standard known as IEEE 802.11.

15. The portable media player of claim 13, further comprising a compression mechanism to compress said signal before transmission.

16. The portable media player of claim 12, further comprising an encryption mechanism to encrypt said signal before transmission.

17. Apparatus comprising:
a wireless communications interface to establish a wireless communications link with a portable media player;
a receiving mechanism to receive a signal from said media player, said signal including an audio signal associated with a medium currently being played in said media player; and
a conversion mechanism for converting said signal into sound which is played via a loudspeaker associated with said apparatus.

18. The apparatus of claim 17, wherein said wireless communications interface comprises a detection mechanism to detect a presence of one or more portable media players.

19. The apparatus of claim 18, further comprising a prompting mechanism to generate a prompt to prompt a user to select said or one of said portable media players with which to establish said wireless communications link.

20. The apparatus of claim 17, wherein said prompting mechanism generates an audio prompt message which is played to said loudspeaker.

21. The apparatus of claim 19, wherein said prompting mechanism generates a visual prompt which is displayed through a visual display associated with said apparatus.

22. The apparatus of claim 18, further comprising an input mechanism to enable a user to input a response to said prompt.
